(19) United States
(12) Patent Application Publication
(10) Pub. No.: US 2023/0304869 A1
(43) Pub. Date: Sep. 28, 2023

(54) MACHINE LEARNING CORRECTION OF TEMPERATURE AND HUMIDITY VALUES

(71) Applicant: Apple Inc., Cupertino, CA (US)

(72) Inventors: Gierad LAPUT, Pittsburgh, PA (US); Brandt M. WESTING, Twisp, WA (US); Jun GONG, Issaquah, WA (US); Runchang KANG, Redmond, WA (US); Michal K. WEGRZYNSKI, Seattle, WA (US); Shmuel G. LINK, Santa Cruz, CA (US); Lian ZHANG, Cupertino, CA (US); Roberto M. RIBEIRO, Sunnyvale, CA (US)

(21) Appl. No.: 18/095,529

(22) Filed: Jan. 10, 2023

Related U.S. Application Data
(60) Provisional application No. 63/323,437, filed on Mar. 24, 2022.

(51) Int. Cl. G01K 3/04; G01N 25/56

(52) U.S. Cl. CPC G01K 3/04; G01N 25/56

(57) ABSTRACT

A method is provided that includes reading a raw temperature value from a temperature sensor mounted in an electronic device and determining an amount of power applied to the electronic device. The method further includes generating, using a trained model, an ambient temperature value based on the raw temperature value and the determined amount of power, wherein the ambient temperature value represents a temperature outside of the electronic device.

### CROSS REFERENCE TO RELATED APPLICATIONS

This application claims the benefit of priority to U.S. Provisional Patent Application No. 63/323,437, entitled, “Machine Learning Correction of Temperature and Humidity Values”, filed on Mar. 24, 2022, the disclosure of which is hereby incorporated herein in its entirety.

### TECHNICAL FIELD

The present description relates generally to sensors in electronic devices including, for example, the correction of sensor readings using machine learning.

### BACKGROUND

Electronic devices may include a number of different sensors. For example, an electronic device may include temperature and humidity sensors intended to detect ambient conditions outside of the electronic device.

### BRIEF DESCRIPTION OF THE DRAWINGS

Certain features of the subject technology are set forth in the appended claims. However, for purpose of explanation, several embodiments of the subject technology are set forth in the following figures.

FIG. 1 is a block diagram illustrating components of an electronic device in accordance with one or more implementations of the subject technology.

FIG. 2 illustrates an example process for determining an ambient temperature outside of an electronic device according to aspects of the subject technology.

FIG. 3 illustrates an example electronic system with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Electronic devices may include a number of sensors. The sensors may include temperature sensors and humidity sensors intended to sense ambient conditions outside of an electronic device in which the sensors are mounted. In addition to sensors, electronic devices may include other components such as processors, memory, network interfaces, etc. When the sensors are mounted in proximity to the other components, heat generated by the other components during operation of the electronic devices may negatively impact the accuracy of the temperature and/or humidity sensor readings.

As system components perform work, they consume power and generate heat. A machine learning model is trained to correct raw values read from the sensors based on the amount of power applied to the system. The corrected values may then be provided for display to a user or provided to applications such as health applications, sleep applications, home automation applications, etc. Although “corrections” to raw values from sensors are described herein, it is appreciated that the raw values (e.g., raw temperature values and/or raw relative humidity values) may correctly and/or accurately represent the micro-environment in which the sensors are disposed (e.g., within a housing of an electronic device), and the “corrections” may be corrections that result in the corrected raw values representing ambient values (e.g., an ambient temperature value and/or an ambient relative humidity value) that substantially correctly and/or accurately represent a broader environment (e.g., outside the electronic device).

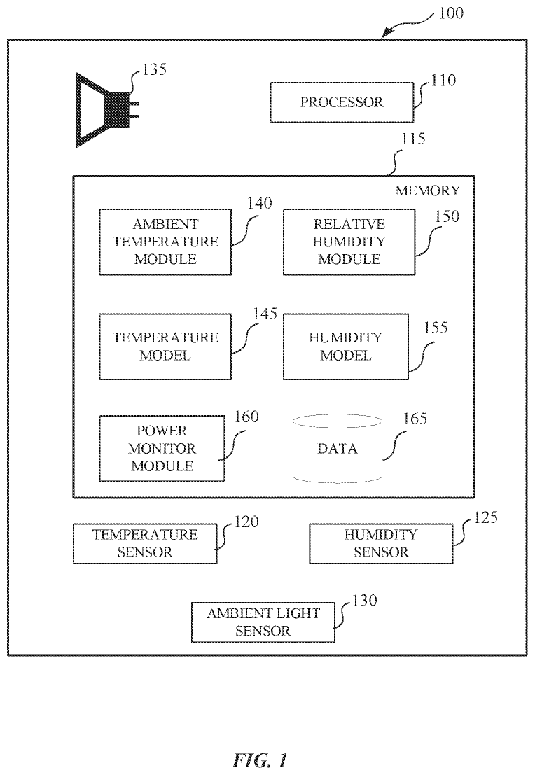

FIG. 1 is a block diagram illustrating components of an electronic device in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example depicted in FIG. 1, electronic device 100 includes processor 110, memory 115, temperature sensor 120, humidity sensor 125, ambient light sensor 130, and media output device 135. Processor 110 may include suitable logic, circuitry, and/or code that enable processing data and/or controlling operations of electronic device 100. In this regard, processor 110 may be enabled to provide control signals to various other components of electronic device 100. Processor 110 may also control transfers of data between various portions of electronic device 100. Additionally, the processor 110 may enable implementation of an operating system or otherwise execute code to manage operations of electronic device 100.

Processor 110 or one or more portions thereof, may be implemented in software (e.g., instructions, subroutines, code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

Memory 115 may include suitable logic, circuitry, and/or code that enable storage of various types of information such as received data, generated data, code, and/or configuration information. Memory 115 may include, for example, random access memory (RAM), read-only memory (ROM), flash memory, and/or magnetic storage. As depicted in FIG. 1, memory 115 contains ambient temperature module 140, temperature model 145, relative humidity module 150, humidity model 155, power monitor module 160, and datastore 165. The subject technology is not limited to these components both in number and type, and may be implemented using more components or fewer components than are depicted in FIG. 1.

According to aspects of the subject technology, ambient temperature module 140 comprises a computer program having one or more sequences of instructions or code together with associated data and settings. Upon executing the instructions or code, one or more processes are initiated to obtain an ambient temperature from a raw temperature value read from temperature sensor 120, such as by accounting for heat sources that may be impacting the ability of temperature sensor 120 to measure the ambient temperature. The raw temperature value is updated to generate the ambient temperature using temperature model 145. Ambient temperature module 140 is configured to provide input data to temperature model 145 to generate an ambient temperature value representing the temperature outside of electronic device 100.

According to aspects of the subject technology, relative humidity module 150 comprises a computer program having one or more sequences of instructions or code together with associated data and settings. Upon executing the instructions or code, one or more processes are initiated to obtain an ambient relative humidity from a raw relative humidity value read from humidity sensor 125, such as by accounting for heat sources that may be impacting the ability of humidity sensor 125 to measure the ambient relative humidity. The raw relative humidity value is updated to generate the ambient relative humidity using humidity model 155. Relative humidity module 150 is configured to provide input data to humidity model 155 to generate a relative humidity value representing the ambient relative humidity outside of electronic device 100.

According to aspects of the subject technology, power monitor module 160 comprises a computer program having one or more sequences of instructions or code together with associated data and settings. Upon executing the instructions or code, one or more processes are initiated to record over time the amount of power being applied to electronic device 100 in datastore 165. Power monitor module 160 may determine the amount of power being applied from power control components (not shown) of electronic device 100.

Temperature model 145 is a machine learning model that has been trained to generate an ambient temperature value that accounts for heat sources that may be negatively impacting the raw temperature value read from temperature sensor 120 from accurately representing the ambient temperature value. Temperature model 145 uses input data provided by ambient temperature module 140 to generate the ambient temperature value. The input data may include the raw temperature value read from temperature sensor 120 and an estimated temperature value that is based on the amount of power applied to the electronic device over a period of time.

In one or more implementations, the estimated temperature value may be determined from an explicit model having learned parameters, such as by calculating the estimated temperature value as A*(applied_power_accumulated_over_X_minutes)−raw_temperature_value+C, in which the scaling factor A, the time X, and the constant C are learned parameters. For example, the scaling factor A, the time X, and the constant C may be determined using the training data used to train temperature model 145. For example, the values may be determined empirically through a series of controlled experiments or through an n-dimensional parameter tuning as part of a machine learning training process. Scaling factor A may have a value between 0 and 1, time X may have a value between, for example one minute and several hours, and constant C may have a value in the range of −3 to +3 representing degrees Celsius. To model the heat dissipation of the electronic device, the power values that are accumulated over the period of time may be exponentially weighted. In one or more other implementations, the temperature model 145 may be implemented as a neural network having weights and/or other parameters that are learned by adjusting the weights and/or other parameters during a training process in which the input data (e.g., input training data, such as training values of the applied_power_accumulated_over_X_minutes and the raw_temperature_value) is provided to the temperature model 145, and a training output of the temperature model 145 is compared to output training data (e.g., known expected temperatures corresponding to the input data), and the weights and/or other parameters are adjusted based on the comparison.

The input data used by temperature model 145 also may include a media playback state and a volume level. For example, media output device 135 may include one or more speakers and one or more amplifiers for driving the one or more speakers. The media playback state may be a binary value that represents whether the speakers and amplifiers of media output device 135 are currently outputting media content. The volume level to which media output device 135 is set is used to represent how much work is being done by the components of media output device 135, where the level of work being done represents the amount of heat being generated by the components. The media playback state value may be multiplied by the volume level with the product provided as input data to temperature model 145. Media output device 135 is not limited to audio components and may include a visual display where a brightness level and/or refresh rate may be used to represent the level of work being done, for example.

The input data used by temperature model 145 also may include temperature readings from other temperature sensors in electronic device 100. For example, components such as processor 110 may include internal temperature sensors, which would indicate a level of heat being generated by those components. The individual temperature readings from the components that have internal temperature sensors may be provided as input data to temperature model 145 or a mean of all of the temperature readings may be provided as the input data.

The input data used by temperature model 145 also may include an output value read from ambient light sensor 130. In this regard, the output value from ambient light sensor 130 may be used to determine if electronic device 100 is exposed to sunlight. For example, if the output value from ambient light sensor 130 exceeds a threshold value electronic device 100 is considered to be exposed to sunlight. It is noted, however, that the ambient temperature and electronic device 100 itself do not immediately heat up once exposed to sunlight. To account for the gradual heating due to exposure to sunlight, historical data values may be used to smooth the data. For example, past raw temperature values read from temperature sensor 120 and the past amounts of power applied to the electronic device (over the previous 300 minutes prior to sunlight exposure, for example) may be used to smooth the output of temperature model 145.

Humidity model 155 is a machine learning model that has been trained to generate a relative humidity value that is corrected for heat sources that may be negatively impacting the raw humidity value read from humidity sensor 125. Humidity model 155 uses input data provided by relative humidity model 150 to generate the relative humidity value. The input data may include the raw humidity value read from humidity sensor 125 and an estimated humidity value that is based on the amount of power applied to the electronic device over a period of time.

In one or more implementations of the subject technology, the estimated humidity value may be determined from an explicit model having learned parameters, such as by calculating the estimated humidity value as A*(applied_power_accumulated_over_X_minutes)−raw_humidity_value+C, where the scaling factor A, the time X, and the constant C are learned parameters. Similar to the temperature model discussed above, the scaling factor A, the time X, and the constant C may be determined using the training data used to train humidity model 155. For example, the values may be determined empirically through a series of controlled experiments or through an n-dimensional parameter tuning as part of a machine learning training process. To further model the heat dissipation of the electronic device, the power values that are accumulated over the period of time may be exponentially weighted. In one or more other implementations, the humidity model 155 may be implemented as a neural network having weights and/or other parameters that are learned by adjusting the weights and/or other parameters during a training process in which the input data (e.g., input training data, such as training values of the applied_power_accumulated_over_X_minutes and the raw_humidity_value) is provided to the humidity model 155, and a training output of the humidity model 155 is compared to output training data (e.g., known expected humidity values corresponding to the input data), and the weights and/or other parameters are adjusted based on the comparison.

The estimated humidity value also, or alternatively, may be determined based on the corrected ambient temperature value generated by temperature model 145 described above. For example, the estimated humidity value may be determined using the following formula:

$${U}_{2} = {U}_{1} \cdot \frac{exp ( \frac{β \cdot {t}_{1}}{λ + {t}_{1}} )}{exp ( \frac{β \cdot {t}_{2}}{λ + {t}_{2}} )}$$

where U₁ is the raw humidity value read from humidity sensor 125, t₁ is the raw temperature value read from temperature sensor 120, t₂ is the corrected ambient temperature value generated by temperature model 145, and β and λ are linear approximation constants.

The input data used by humidity model 155 also may include the media playback state and volume level, the temperature readings from other temperature sensors in electronic device 100, and the output value read from ambient light sensor 130 discussed above with respect to the temperature model.

When electronic device 100 is first powered on, datastore 165 does not yet have X minutes of applied power data needed to determine the estimated temperature value and the estimated humidity value discussed above. Initially, electronic device 100 may be treated as if it has been in an idle state for the previous X minutes and the missing applied power data is backfilled using an average amount of power applied to the electronic device in an idle state. As electronic device 100 is used, such as by playing back media content using media output device 135, the missing applied power data is backfilled using a blend of the average amount of power applied to the electronic device in an idle state and an average amount of power applied to the electronic device in an active state. The blending may be based on a ratio of the time the electronic device is idle and the time the electronic device is active.

According to aspects of the subject technology, training data for training temperature model 145 and humidity model 155 may be collected using multiple electronic devices of the same type together with reference temperature/humidity sensors. For example, each electronic device may be mounted a specified distance from a respective reference temperature/humidity sensor and the electronic devices with their respective reference temperature/humidity sensors may be placed in different locations having a variety of temperature and/or humidity conditions. Over time, samples of the input data described above used for the two models may be collected from the electronic devices and corresponding samples of the ambient temperature and relative humidity may be collected from the reference temperature/humidity sensors.

Ambient temperature module 140 and temperature model 145 are described above as being implemented in software. According to aspects of the subject technology, ambient temperature module 140 and temperature model 145 may be implemented in hardware using dedicated circuitry configured to generate the ambient temperature value and provide the value to processor 110. The hardware implementation also may incorporate temperature sensor 120. Similarly, relative humidity module 150 and humidity model 155 also may be implemented in hardware using dedicated circuitry configured to generate the relative humidity value and provide the value to processor 110. The hardware implementation also may incorporate humidity sensor 125.

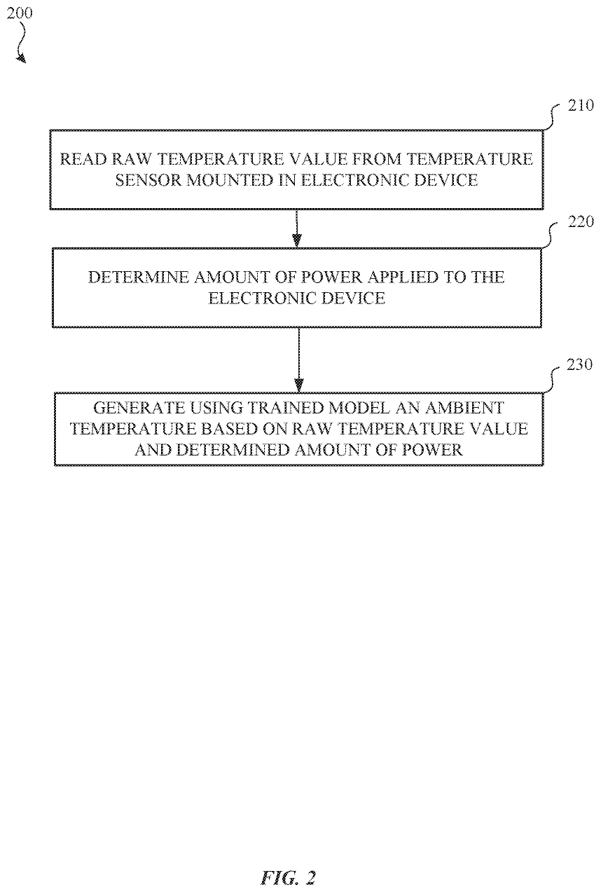

FIG. 2 illustrates an example process for determining an ambient temperature outside of an electronic device according to aspects of the subject technology. For explanatory purposes, the blocks of process 200 are described herein as occurring in serial, or linearly. However, multiple blocks of process 200 may occur in parallel. In addition, the blocks of process 200 need not be performed in the order shown and/or one or more blocks of process 200 need not be performed and/or can be replaced by other operations.

Example process 200 may be initiated in response to a request from an application for the current ambient temperature or may be periodically initiated to generate and store the ambient temperature over time. After initiation, process 200 includes reading a raw temperature value from a temperature sensor mounted in an electronic device (block 210). Process 200 further includes determining an amount of power applied to the electronic device (block 220). As discussed above, the amount of power being applied to the electronic device is used as a proxy for heat being generated by the electronic device. An ambient temperature is generated using a trained model based on the raw temperature value and the determined amount of power (block 230).

The generated ambient temperature (and/or the relative humidity) may be provided for display to a user or may be provided to an application, such as a health application, a sleep application, a home automation application, etc. The application may be running on the electronic device containing the sensor or on another device such as a smartphone or smartwatch. When running on another device, the proximity of the other device to the electronic device containing the sensor may be significant for purposes of the application. For example, the location of the other device may be used as a proxy for the location of the user of that device. A health or sleep application may be configured to use the temperature and/or relative humidity that the user is experiencing for health or sleep analysis. Proximity between the two devices may be determined using short-range radio technologies such as Bluetooth and ultra wideband (UWB). Once proximity is established, the electronic device with the sensor may make the generated ambient temperature and/or relative humidity available to the application on the other device.

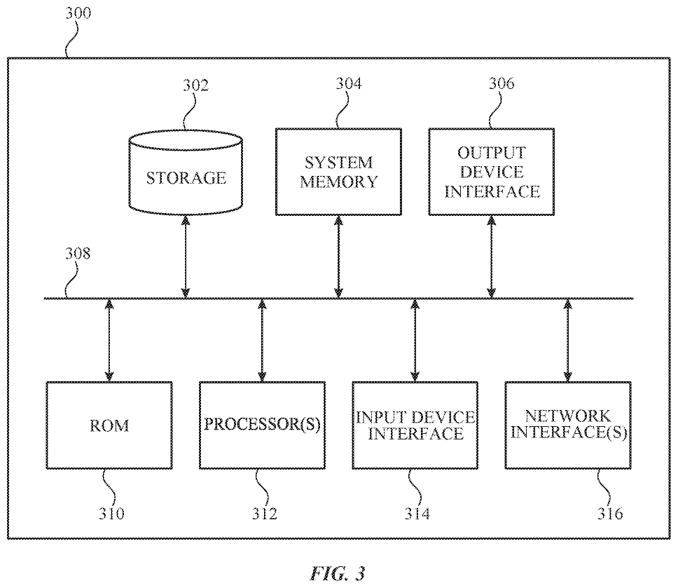

FIG. 3 illustrates an electronic system 300 with which one or more implementations of the subject technology may be implemented. Electronic system 300 can be, and/or can be a part of, electronic device 100 shown in FIG. 1. The electronic system 300 may include various types of computer readable media and interfaces for various other types of computer readable media. The electronic system 300 includes a bus 308, one or more processing unit(s) 312, a system memory 304 (and/or buffer), a ROM 310, a permanent storage device 302, an input device interface 314, an output device interface 306, and one or more network interfaces 316, or subsets and variations thereof.

The bus 308 collectively represents all system, peripheral, and chipset buses that communicatively connect the numerous internal devices of the electronic system 300. In one or more implementations, the bus 308 communicatively connects the one or more processing unit(s) 312 with the ROM 310, the system memory 304, and the permanent storage device 302. From these various memory units, the one or more processing unit(s) 312 retrieves instructions to execute and data to process in order to execute the processes of the subject disclosure. The one or more processing unit(s) 312 can be a single processor or a multi-core processor in different implementations.

The ROM 310 stores static data and instructions that are needed by the one or more processing unit(s) 312 and other modules of the electronic system 300. The permanent storage device 302, on the other hand, may be a read-and-write memory device. The permanent storage device 302 may be a non-volatile memory unit that stores instructions and data even when the electronic system 300 is off. In one or more implementations, a mass-storage device (such as a magnetic or optical disk and its corresponding disk drive) may be used as the permanent storage device 302.

In one or more implementations, a removable storage device (such as a floppy disk, flash drive, and its corresponding disk drive) may be used as the permanent storage device 302. Like the permanent storage device 302, the system memory 304 may be a read-and-write memory device. However, unlike the permanent storage device 302, the system memory 304 may be a volatile read-and-write memory, such as random access memory. The system memory 304 may store any of the instructions and data that one or more processing unit(s) 312 may need at runtime. In one or more implementations, the processes of the subject disclosure are stored in the system memory 304, the permanent storage device 302, and/or the ROM 310. From these various memory units, the one or more processing unit(s) 312 retrieves instructions to execute and data to process in order to execute the processes of one or more implementations.

The bus 308 also connects to the input and output device interfaces 314 and 306. The input device interface 314 enables a user to communicate information and select commands to the electronic system 300. Input devices that may be used with the input device interface 314 may include, for example, alphanumeric keyboards and pointing devices (also called “cursor control devices”). The output device interface 306 may enable, for example, the display of images generated by electronic system 300. Output devices that may be used with the output device interface 306 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 3, the bus 308 also couples the electronic system 300 to one or more networks and/or to one or more network nodes, such as the content provider 112 shown in FIG. 1, through the one or more network interface(s) 316. In this manner, the electronic system 300 can be a part of a network of computers (such as a LAN, a wide area network (“WAN”), or an Intranet, or a network of networks, such as the Internet. Any or all components of the electronic system 300 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

In accordance with the subject disclosure, a method is provided. The method includes reading a raw temperature value from a temperature sensor mounted in an electronic device and determining an amount of power applied to the electronic device. The method further includes generating, using a trained model, an ambient temperature value based on the raw temperature value and the determined amount of power, wherein the ambient temperature value represents a temperature outside of the electronic device.

Determining the amount of power applied to the electronic device may include accumulating the amount of power applied to the electronic device over a period of time. The amount of power applied to the electronic device over the period of time may be exponentially weighted. An average power may be used for the amount of power applied to the electronic device for a portion of the period of time when the electronic device has not been connected to power for the entire period of time. The average power may be a blend of an average idle power and an average active power, and wherein the blend is based on activity of the electronic device since the electronic device was connected to power.

The method may further include determining a media playback state of the electronic device, wherein the ambient temperature value may be generated, using the trained model, further based on the media playback state of the electronic device. The method may further include determining a volume setting of the electronic device, wherein the ambient temperature value is generated, using the trained mode, further based on the volume setting of the electronic device.

The method may further include reading a light value from an ambient light sensor of the electronic device, wherein the ambient temperature value is generated, using the trained model, further based on the light value read from the ambient light sensor. The method may further include comparing the light value against a threshold, wherein the ambient temperature value is generated, using the trained model, further based on the light value read from the ambient light sensor if the light value satisfies the threshold.

The ambient temperature value may be different from the raw temperature value. The trained model may be trained using a dataset comprising values recorded from a plurality of devices of the same type as the electronic device and a plurality of reference sensors.

In accordance with the subject disclosure, a non-transitory computer-readable medium storing instructions is provided. The instructions, when executed by one or more processors, cause the one or more processors to perform operations including reading a raw temperature value from a temperature sensor mounted in an electronic device and determining an amount of power applied to the electronic device accumulated over a period of time. The operations further include generating, using a trained model, an ambient temperature value based on the raw temperature value and the determined amount of power, wherein the ambient temperature value represents a temperature outside of the electronic device.

The amount of power applied to the electronic device over the period of time may be exponentially weighted. An average power may be used for the amount of power applied to the electronic device for a portion of the period of time when the electronic device has not been connected to power for the entire period of time. The average power may be a blend of an average idle power and an average active power, and wherein the blend is based on activity of the electronic device since the electronic device was connected to power.

The operations may further include determining a media playback state of the electronic device and determining a volume setting of the electronic device, wherein the ambient temperature value is generated, using the trained model, further based on the media playback state and the volume setting of the electronic device. The operations may further include reading a light value from an ambient light sensor of the electronic device and comparing the light value against a threshold, wherein the ambient temperature value is generated, using the trained model, further based on the light value read from the ambient light sensor if the light value satisfies the threshold.

In accordance with the subject disclosure, an electronic device is provided that includes an environmental sensor, a memory storing a plurality of computer programs and one or more processors configured to execute instructions of the plurality of computer programs. The instructions are executed to read a raw value from the environmental sensor and determine an amount of power applied to the electronic device accumulated over a period of time. The instructions are further executed to generate, using a trained model, an ambient value based on the raw value and the determined amount of power, wherein the ambient value represents an environmental condition outside of the electronic device.

The environmental sensor may be a temperature sensor, and the environmental condition may be an ambient temperature. The environmental sensor may be a humidity sensor, and the environmental condition may be a humidity value.

The instructions may be further executed to determine a media playback state of the electronic device and determine a volume setting of the electronic device, wherein the ambient temperature value is generated, using the trained model, further based on the media playback state and the volume setting of the electronic device.

The instructions may be further executed to read a light value from an ambient light sensor of the electronic device and compare the light value against a threshold, wherein the ambient temperature value is generated, using the trained model, further based on the light value read from the ambient light sensor if the light value satisfies the threshold.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
reading a raw temperature value from a temperature sensor mounted in an electronic device;
determining an amount of power applied to the electronic device; and
generating, using a trained model, an ambient temperature value based on the raw temperature value and the determined amount of power, wherein the ambient temperature value represents a temperature outside of the electronic device.

2. The method of claim 1, wherein determining the amount of power applied to the electronic device comprises accumulating the amount of power applied to the electronic device over a period of time.

3. The method of claim 2, wherein the amount of power applied to the electronic device over the period of time is exponentially weighted.

4. The method of claim 2, wherein an average power is used for the amount of power applied to the electronic device for a portion of the period of time when the electronic device has not been connected to power for an entirety of the period of time.

5. The method of claim 4, wherein the average power is a blend of an average idle power and an average active power, and wherein the blend is based on activity of the electronic device since the electronic device was connected to power.

6. The method of claim 1, further comprising:
determining a media playback state of the electronic device; and
determining a volume setting of the electronic device,
wherein the ambient temperature value is generated, using the trained model, further based on the media playback state of the electronic device and the volume setting of the electronic device.

7. The method of claim 1, wherein the trained model is trained using a dataset comprising values recorded from a plurality of devices of the same type as the electronic device and a plurality of reference sensors.

8. The method of claim 1, further comprising:
reading a light value from an ambient light sensor of the electronic device; and
comparing the light value against a threshold,
wherein the ambient temperature value is generated, using the trained model, further based on the light value read from the ambient light sensor if the light value satisfies the threshold.

9. The method of claim 1, wherein the ambient temperature value is different from the raw temperature value.

10. The method of claim 1, further comprising determining an ambient humidity value from the ambient temperature value.

11. A non-transitory computer-readable medium storing instructions which, when executed by one or more processors, cause the one or more processors to perform operations comprising:
reading a raw temperature value from a temperature sensor mounted in an electronic device;
determining an amount of power applied to the electronic device accumulated over a period of time; and
generating, using a trained model, an ambient temperature value based on the raw temperature value and the determined amount of power, wherein the ambient temperature value represents a temperature outside of the electronic device.

12. The non-transitory computer-readable medium of claim 11, wherein the amount of power applied to the electronic device over the period of time is exponentially weighted.

13. The non-transitory computer-readable medium of claim 11, wherein an average power is used for the amount of power applied to the electronic device for a portion of the period of time when the electronic device has not been connected to power for an entirety of the period of time.

14. The non-transitory computer-readable medium of claim 13, wherein the average power is a blend of an average idle power and an average active power, and wherein the blend is based on activity of the electronic device since the electronic device was connected to power.

15. The non-transitory computer-readable medium of claim 11, wherein the operations further comprise:
determining a media playback state of the electronic device; and
determining a volume setting of the electronic device,
wherein the ambient temperature value is generated, using the trained model, further based on the media playback state and the volume setting of the electronic device.

16. The non-transitory computer-readable medium of claim 11, wherein the operations further comprise:
reading a light value from an ambient light sensor of the electronic device; and
comparing the light value against a threshold,
wherein the ambient temperature value is generated, using the trained model, further based on the light value read from the ambient light sensor if the light value satisfies the threshold.

17. An electronic device, comprising:
an environmental sensor;
a memory storing a plurality of computer programs; and
one or more processors configured to execute instructions of the plurality of computer programs to:
read a raw value from the environmental sensor;
determine an amount of power applied to the electronic device accumulated over a period of time; and
generate, using a trained model, an ambient value based on the raw value and the determined amount of power, wherein the ambient value represents an environmental condition outside of the electronic device.

18. The electronic device of claim 17, wherein the environmental sensor is a temperature sensor, and the environmental condition is an ambient temperature.

19. The electronic device of claim 17, wherein the environmental sensor is a humidity sensor, and the environmental condition is a humidity value.

20. The electronic device of claim 17, wherein the one or more processors are configured to execute instructions of the plurality of computer programs to:
determine a media playback state of the electronic device; and
determine a volume setting of the electronic device,
wherein the ambient value is generated, using the trained model, further based on the media playback state and the volume setting of the electronic device.

21. The electronic device of claim 17, wherein the one or more processors are configured to execute instructions of the plurality of computer programs to:
read a light value from an ambient light sensor of the electronic device; and
compare the light value against a threshold,
wherein the ambient value is generated, using the trained model, further based on the light value read from the ambient light sensor if the light value satisfies the threshold.
